(19) United States
(12) Patent Application Publication
(10) Pub. No.: US 2026/0027833 A1
(43) Pub. Date: Jan. 29, 2026

(54) IMAGE FORMING APPARATUS

(71) Applicant: KYOCERA Document Solutions Inc., Osaka (JP)

(72) Inventor: Susumu HANANO, Osaka (JP)

(73) Assignee: KYOCERA Document Solutions Inc., Osaka (JP)

(21) Appl. No.: 19/263,969

(22) Filed: Jul. 9, 2025

(30) Foreign Application Priority Data
Jul. 25, 2024 (JP) 2024-119407

(51) Int. Cl. B41J 2/175

(52) U.S. Cl. CPC B41J 2/1752; B41J 2/17546

(57) ABSTRACT

An image forming apparatus includes a container, a mounting portion, and an image forming portion, the container including a tag plate, the mounting portion including a tray, a holder, a switch, and an actuator. The tag plate includes a first section formed in a shape that corresponds to one of a plurality of different shapes determined in advance as options for a shape of the actuator. When the tray is inserted, if the first section of the tag plate having been entered into the holder has a shape that corresponds to the shape of the actuator, the actuator is pressed in an insertion direction by the first section.

### INCORPORATION BY REFERENCE

This application is based on and claims the benefit of priority from Japanese Patent Application No. 2024-119407 filed on Jul. 25, 2024, the contents of which are hereby incorporated by reference.

### BACKGROUND

The present disclosure relates to an image forming apparatus.

Image forming apparatuses each include a container that contains a color material, such as ink, toner, or the like. Image forming apparatuses perform printing by using the color material contained in the container.

The container is attachable to and detachable from a main body of an image forming apparatus. When the container attached to the main body becomes empty, it is detached from the apparatus main body, and a new container is attached to the apparatus main body instead. At this time, an incompatible container might unintentionally be attached to the image forming apparatus, causing inconvenience.

### SUMMARY

According to one aspect of the present disclosure, an image forming apparatus includes a container, a mounting portion, and an image forming portion. The container contains a color material. The mounting portion has the container mounted therein in an attachable and detachable manner. The image forming portion forms an image on a sheet by using the color material. The container includes a tag plate including an IC tag in which color material information related to the color material is stored in advance. The mounting portion includes a tray, a holder, a switch, and an actuator. The tray is insertable into and removable from a main body of the image forming apparatus, and the container is set thereon. The holder is disposed on the tray and holds the tag plate of the container set on the tray by having the tag plate entered thereinto. The switch is disposed on the main body and turns on and off by being pressed in an insertion direction, in which the tray is inserted into the main body. The actuator is supported so as to be movable in the insertion direction and that moves in the insertion direction by being pressed in the insertion direction, thereby pressing the switch in the insertion direction. The tag holder includes a first section that protrudes toward the insertion direction from the holder in the insertion direction in a state where the tag plate has been entered into the holder. The first section is formed in a shape that corresponds to one of a plurality of different shapes determined in advance as options for a shape of the actuator. When the tray is inserted into the main body, if the first section of the tag plate having been entered into the holder has a shape that corresponds to the shape of the actuator, the actuator is pressed by the first section in the insertion direction.

### BRIEF DESCRIPTION OF THE DRAWINGS

FIG. 1 is a schematic diagram of an inkjet recording apparatus according to one embodiment.

FIG. 2 is a perspective view of an ink pack according to one embodiment.

FIG. 3 is a perspective view of and around a mounting portion in a main body according to one embodiment as seen from a front side.

FIG. 4 is a perspective view of a state where an ink pack is set on a tray of a mounting portion according to one embodiment (a state where a tag plate has been entered into a holder).

FIG. 5 is a perspective view of a state where an ink pack is set on a tray of a mounting portion according to one embodiment (a state where a tag plate has not been entered into a holder).

FIG. 6 is a perspective view of and around an actuator according to one embodiment.

FIG. 7 is a perspective view of and around an actuator (that has a different shape from the one shown in FIG. 6) according to one embodiment.

FIG. 8 is a plan view of a tag plate according to one embodiment as seen from a plate thickness direction thereof.

FIG. 9 is a plan view of a tag plate (that has a different shape from the one shown in FIG. 8) according to one embodiment as seen from a plate thickness direction thereof.

FIG. 10 is a diagram schematically showing a positional relationship between the tag plate shown in FIG. 8 and an actuator corresponding to the tag plate as seen from a front-rear direction.

FIG. 11 is a diagram schematically showing a positional relationship between the tag plate shown in FIG. 9 and an actuator corresponding to the tag plate as seen from the front-rear direction.

FIG. 12 is a perspective view showing a state where a switch has been pressed down by the actuator shown in FIG. 10.

FIG. 13 is a perspective view showing a state where a switch has been pressed down by the actuator shown in FIG. 11.

FIG. 14 is a diagram schematically showing a positional relationship between the tag plate shown in FIG. 9 and the actuator shown in FIG. 10 as seen from the front-rear direction.

FIG. 15 is a perspective view of a state where a tag plate according to one embodiment has been entered into a holder.

FIG. 16 is a perspective view showing a state where the tag plate shown in FIG. 15 has not been entered into the holder.

### DETAILED DESCRIPTION

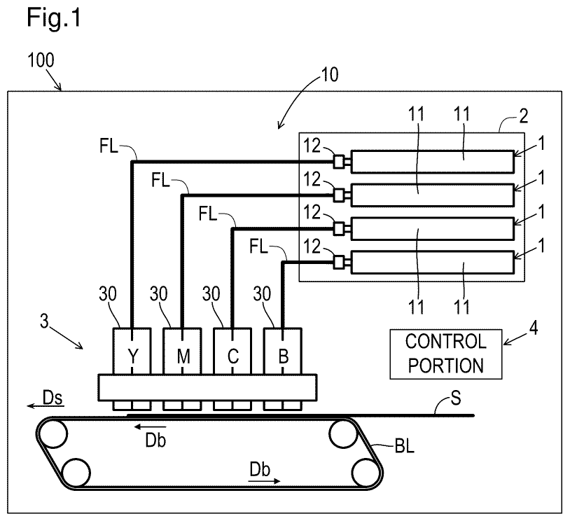

Hereinafter, with reference to FIGS. 1 to 16, an inkjet recording apparatus 100 of the present embodiment will be described. The inkjet recording apparatus 100 is equivalent to an “image forming apparatus.” The inkjet recording apparatus 100 performs printing on a sheet S by using ink as a color material. The sheet S is a copy paper sheet, a coated paper sheet, an OHP sheet, a paperboard, a postcard, a tracing paper sheet, a corrugated cardboard sheet, a cloth sheet, or the like.

Note that the present disclosure is not solely applicable to image forming apparatuses that use ink as the color material but is applicable also to image forming apparatuses that use toner as the color material.

[Configuration of Inkjet Recording Apparatus]A schematic configuration of the inkjet recording apparatus 100 is shown in FIG. 1. For example, the inkjet recording apparatus 100 is a comparatively large-sized apparatus used for commercial printing. That is, the inkjet recording apparatus 100 is not designed for domestic use.

However, the present disclosure is also applicable to image forming apparatuses for domestic use.

The inkjet recording apparatus 100 includes an ink pack 1. The ink pack 1 is mounted in a main body 10 of the inkjet recording apparatus 100. The ink pack 1 contains ink to be used for printing. The ink pack 1 is equivalent to a “container.”

The inkjet recording apparatus 100 includes a mounting portion 2. The mounting portion 2 includes a mounting region for mounting the ink pack 1. The ink pack 1 is mounted in the mounting portion 2 in an attachable and detachable manner. When the ink pack 1 becomes empty of the ink, the ink pack 1 is replaced with a brand new one.

The inkjet recording apparatus 100 includes an image forming portion 3. The image forming portion 3 includes four recording heads 30 each corresponding to one of four colors: cyan, magenta, yellow, and black. In FIG. 1, a sign “C” is added to the recording head 30 corresponding to cyan, a sign “M” is added to the recording head 30 corresponding to magenta, a sign “Y” is added to the recording head 30 corresponding to yellow, and a sign “B” is added to the recording head 30 corresponding to black.

The recording heads 30 are arranged to be spaced from each other in one direction. Further, the recording heads 30 each have a nozzle surface where a plurality of nozzles are disposed. The recording heads 30 eject ink from the nozzles of their nozzle surfaces.

For example, the inkjet recording apparatus 100 includes a conveyance belt BL. The conveyance belt BL travels while carrying a sheet S on a surface thereof. The surface of the conveyance belt BL faces the nozzle surfaces of the recording heads 30. During the conveyance of the sheet S by the conveyance belt BL, the nozzle surfaces of the recording heads 30 face the sheet S. The recording heads 30 eject ink toward the sheet S. Thereby, an image is formed on the sheet S. In FIG. 1, a direction indicated by an arrow Ds is a conveyance direction in which the sheet S is conveyed. Further, a direction indicated by an arrow Db is a travel direction in which the conveyance belt BL travels.

The inkjet recording apparatus 100 includes a control portion 4. The control portion 4 incorporates processing circuits, such as a CPU, an ASIC, etc. The control portion 4 incorporates memory devices, such as a ROM, a RAM, an HDD, an SSD, etc. The control portion 4 controls printing performed by the inkjet recording apparatus 100.

### <Ink Pack>

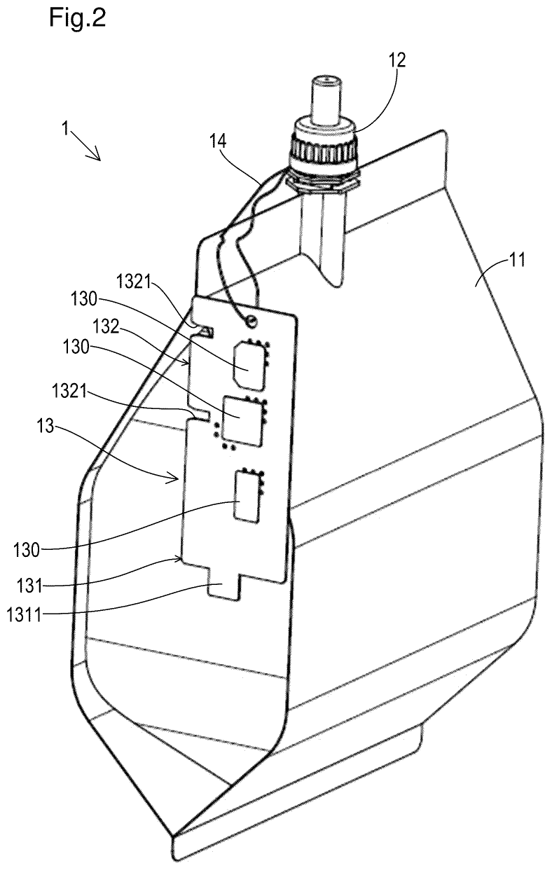

The ink pack 1 has a configuration as shown in FIG. 2. The inkjet recording apparatus 100 has mounted therein a plurality of ink packs 1 each corresponding to one of cyan, magenta, yellow, and black. Each of the ink packs 1 contains ink of its corresponding color.

There is no specific limitation on the number of the ink packs 1 to be mounted in the inkjet recording apparatus 100. For example, in the inkjet recording apparatus 100, a plurality of ink packs 1 are mounted with respect to each color. That is, in the inkjet recording apparatus 100, a plurality of (e.g., a total of 12) ink packs 1 are mounted.

Hereinafter, a configuration of the ink packs 1 will be described, with a focus on one of them. The ink packs 1 are all identical in configuration. Thus, descriptions of the configurations of the other ink packs 1 will be omitted to refer to the following description.

The ink pack 1 includes a pack main body 11. The pack main body 11 is formed of an aluminum laminate film in a bag-like shape. Ink is contained in the pack main body 11.

The ink pack 1 includes a spout 12. The spout 12 is a cylinder-shaped member and is fitted to the pack main body 11. The spout 12 allows communication between inside and outside of the pack main body 11. Thereby, the ink in the pack main body 11 is allowed to flow out via the spout 12.

The spout 12 is attachable to and detachable from an ink flow path FL (see FIG. 1) that leads to the recording head 30. With the spout 12 connected to the ink flow path FL, the ink is allowed to be supplied from the ink pack 1 to the recording head 30.

The ink pack 1 includes a tag plate 13. The tag plate 13 includes an IC tag 130. The tag plate 13 is assigned to each ink pack 1 one by one. The tag plate 13 is a plate-shaped member made of resin, for example. The IC tag 130 is mounted on one side of the tag plate 13. In the IC tag 130, ink information (equivalent to “color material information”) related to the ink contained in the corresponding ink pack 1 is stored in advance.

There are no specific limitations on what should be included in the ink information. As the ink information, various pieces of information, including ink color, ink composition, lot number, and more, are stored in the IC tag 130 in advance.

For example, the ink pack 1 includes a string member 14. The tag plate 13 is connected to the spout 12 via the string member 14. In other words, the tag plate 13 is hung from the spout 12 via the string member 14. Thereby, the tag plate 13 is allowed to be freely moved with respect to the spout 12.

There are no specific limitations on what type of string the string member 14 should be. The string member 14 may be a resin string, or may be a fabric string. The string member 14 may be a metal string, such as a ball chain, an extra-fine wire, or the like.

### <Mounting Portion>

Hereinafter, configurations of and positional relationships between components of the mounting portion 2 will be described using an XYZ orthogonal coordinate system to aid understanding. An X direction, along the X axis, is one horizontal direction, and is equivalent to a front-rear direction of the inkjet recording apparatus 100. A Y direction, along the Y axis, is the other horizontal direction, and is equivalent to a left-right direction of the inkjet recording apparatus 100. A Z direction, along the Z axis, is a vertical direction, and is equivalent to an up-down direction of the inkjet recording apparatus 100.

In the following description, the X direction will be referred to as the front-rear direction, the Y direction will be referred to as the left-right direction, and the Z direction will be referred to as the up-down direction.

Note that the side pointed by the arrow of the X axis is a rear side (a back side), and the opposite side is a front side (a face side). Note that the side pointed by the arrow of the Y axis is a left side, and the opposite side is a right side. Note that the side pointed by the arrow of the X axis is an upper side, and the opposite side is a lower side.

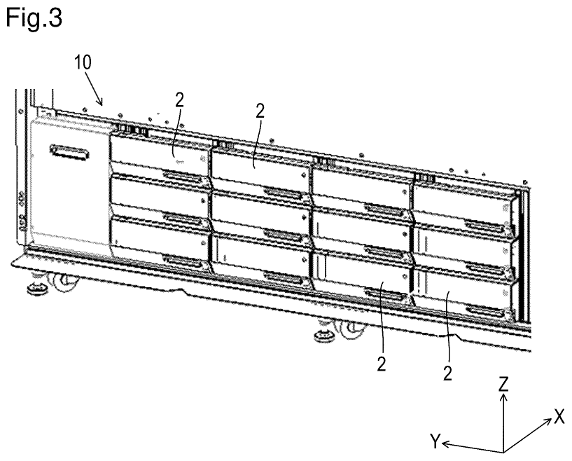

As shown in FIG. 3, the mounting portion 2 includes a plurality of mounting portions 2. The mounting portion 2 includes the same number of mounting portions 2 as the ink packs 1. As seen from the front side of the inkjet recording apparatus 100, the plurality of mounting portions 2 are aligned in the up-down direction and in the left-right direction. The plurality of mounting portions 2 each correspond to one of four colors: cyan, magenta, yellow, and black. The plurality of mounting portions 2 each have an ink pack 1 containing ink of the corresponding color mounted therein. For example, the plurality of mounting portions 2 are each covered with a cover from the front side. Note that, in the state shown in FIG. 3, the mounting portions 2 are each covered with the cover, so that interiors thereof are not visually recognizable.

Hereinafter, the configuration of the mounting portions 2 will be described, with a focus on one of them. The mounting portions 2 are all identical in configuration. Thus, descriptions of the configurations of the other mounting portions 2 will be omitted to refer to the following description.

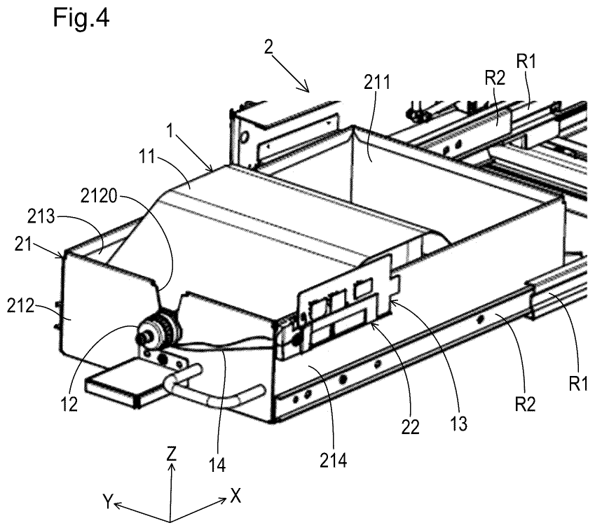

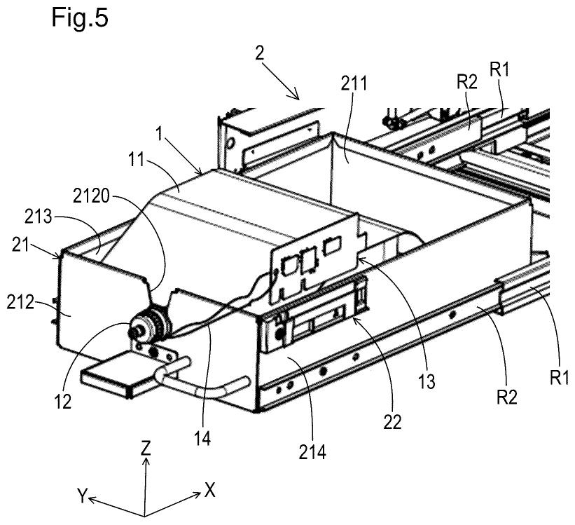

As shown in FIGS. 4 and 5, the mounting portion 2 includes a tray 21. The tray 21 includes a set region. The ink pack 1 is set in the set region of the tray 21.

The tray 21 has a substantially box-like shape with an opening on an upper side thereof.

That is, the tray 21 includes a bottom part (sign omitted) that is parallel to an XY plane. Further, the tray 21 includes a pair of side parts 211 and 212 that are parallel to a YZ plane and face each other in the front-rear direction, and a pair of side parts 213 and 214 that are parallel to a ZX plane and face each other in the left-right direction. The side parts 211 to 214 stand upward from edges of the bottom part. The tray 21 has a region that is enclosed by the side parts 211 to 214 and situated over the bottom part as the set region. The ink pack 1 is placed on the bottom part of the tray 21.

Note that the side part 211 is positioned on the rear side, and the side part 212 is positioned on the front side. Further, the side part 213 is positioned on the left side, and the side part 214 is positioned on the right side.

In a state where the ink pack 1 is set on the tray 21, the spout 12 is disposed outside the set region. For example, the side part 212 on the front side has an opening 2120 that is cut downward from an upper edge of the side part 212. The spout 12 has its trunk part fitted in the opening 2120. The spout 12 protrudes from inside to outside of the set region via the opening 2120.

The tray 21 is insertable into and removable from the main body 10. The ink pack 1 is replaceable by pulling the tray 21 out from the main body 10. FIGS. 4 and 5 each show a state where the tray 21 has been pulled out from the main body 10.

For example, the mounting portion 2 includes two slide rails each composed of an outer rail R1 and an inner rail R2. The outer rail R1 and the inner rail R2 each extend in the front-rear direction. The outer rail R1 is fitted to the main body 10. The inner rail R2 is fitted to an outer surface of each of the side parts 213 and 214 of the tray 21. The inner rail R2, which is inserted in the outer rail R1 in the front-rear direction, is slidable in the rear-front direction while being guided by the outer rail R1.

In a state where the tray 21 has been inserted into the main body 10, by sliding the tray 21 frontward, the tray 21 is pulled out from the main body 10. In a state where the tray 21 has been pulled out from the main body 10, by sliding the tray 21 rearward, the tray 21 is inserted into the main body 10. In this configuration, a direction in which the tray 21 slides toward the front side is equivalent to an insertion direction of the tray 21 into the main body 10. In the following direction, the insertion direction of the tray 21 into the main body 10 will be simply referred to as the tray insertion direction. The direction indicated by the arrow of the X axis is the tray insertion direction.

The mounting portion 2 includes a holder 22. The holder 22 is disposed on an outer surface of the side part 214 of the tray 21. The holder 22 holds the tag plate 13 of the ink pack 1 set on the tray 21. In a state where the tag plate 13 is held by the holder 22, the tag plate 13 has a plate thickness direction thereof aligned with the left-right direction. The tag plate 13 is mounted on a mounting surface that is oriented outward relative to the set region.

The holder 22 has an entry region into which the tag plate 13 is entered. The tag plate 13 is entered into the holder 22 in a direction from an upper side to a lower side. In this configuration, an entry direction of the tag plate 13 into the holder 22 is the direction from the upper side to the lower side. In the following description, the entry direction of the tag plate 13 into the holder 22 will be referred to simply as the tag entry direction. A direction opposite to the direction indicated by the arrow of the Z axis is the tag entry direction. FIG. 4 shows a state where the tag plate 13 has been entered into the holder 22. FIG. 5 shows a state where the tag plate 13 is about to be entered into the holder 22 (or a state where the tag plate 13 has just been pulled out from the holder 22).

The tag plate 13 is entered into the holder 22 (the entry region thereof) so as to be held by the holder 22. The IC tag 130 is mounted on such part of the tag plate 13 that protrudes upward from the holder 22 in the state where the tag plate 13 has been entered into the holder 22.

Note that the ink pack 1 is mounted on the tray 21 manually by a user. Further, the tag plate 13 is entered into the holder 22 manually by the user.

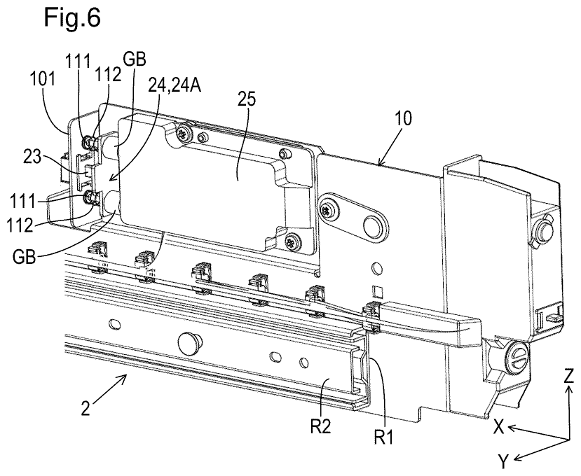

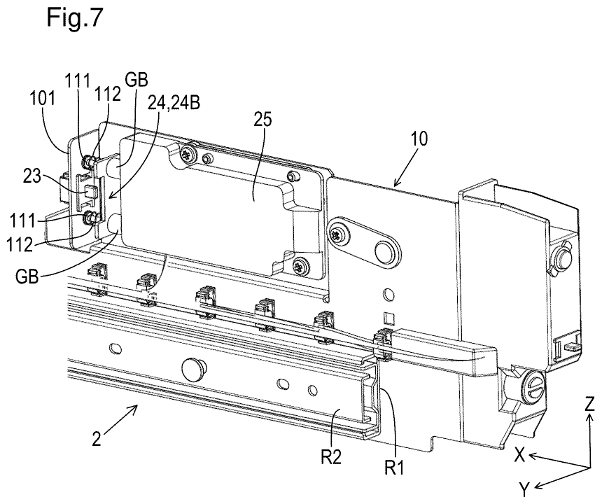

Furthermore, as shown in FIGS. 6 and 7, the mounting portion 2 includes a switch 23. Usable as the switch 23 is a push-button switch, for example. A substrate including the switch 23 is connected to the control portion 4. The control portion 4 detects whether the switch 23 is on or off.

The switch 23 is disposed on a base 101, which is part of the main body 10. The base 101 has a plate-like shape with a plate thickness direction thereof aligned with the front-rear direction. A main body of the switch 23 is disposed on a rear surface side of the base 101. A leading end part of the switch 23, which is a pressed portion (in other words, a portion to be pressed by another member) of the switch 23, protrudes frontward from a front surface of the base 101. The switch 23 is turned on and off by pressing the leading end part thereof from the front side toward the rear side. In other words, the switch 23 is pressed in the tray insertion direction to be turned on and off.

The mounting portion 2 includes an actuator 24. The actuator 24 is a plate-shaped member with a thickness direction thereof aligned with the front-rear direction. The actuator 24 is disposed frontward of the base 101, and faces the base 101 in the front-rear direction.

The actuator 24 is supported to be reciprocatable in the front-rear direction. For example, on the base 101, two guide pins 111 are disposed so as to extend frontward. The actuator 24 includes two guide bushes GB into which the two guide pins 111 are respectively inserted. The actuator 24 is reciprocatable in the front-rear direction while being guided by the two guide pins 111.

Around each of the two guide pins 111, a compression coil spring 112 is disposed. That is, between the base 101 and the actuator 24 in the front-rear direction, compression coil springs 112 are disposed. The compression coil springs 112 generate a biasing force that acts to separate the base 101 (that is, the switch 23) and the actuator 24 from each other.

The actuator 24 is disposed frontward of the switch 23. The actuator 24 faces the leading end part of the switch 23 across a space in the front rear direction. By being pressed in the tray insertion direction, the actuator 24 is caused to move in the tray insertion direction to press the leading end part of the switch 23 in the tray insertion direction. That is, the actuator 24 turns the switch 23 on and off by being pressed in the tray insertion direction. For example, the switch 23 turns on when it is pressed by the actuator 24 and turns off when the pressing by the actuator 24 is released.

The mounting portion 2 includes a tag reader 25. The tag reader 25 is an RFID reader. The tag reader 25 is disposed on the main body 10. In a state where the tray 21 has been inserted into the main body 10, the tag reader 25, in the left-right direction, faces the IC tag 130 of the tag plate 13 having been entered into the holder 22. The tag reader 25 wirelessly communicates with the IC tag 130 to read the ink information stored in the IC tag 130 in advance.

The tag reader 25 is connected to the control portion 4. The control portion 4 controls the tag reader 25. When the switch 23 has turned on, the control portion 4 determines that the tray 21 has been mounted in the main body 10 and makes the tag reader 25 read the IC tag 130. The control portion 4 recognizes the ink information read by the tag reader 25. Upon recognizing the ink information of all the ink packs 1 respectively mounted in the plurality of mounting portions 2, the control portion 4 permits printing to be performed by the inkjet recording apparatus 100. If the control portion 4 fails to recognize the ink information of any of the ink packs 1 mounted in the mounting portions 2, printing is not executed in the inkjet recording apparatus 100.

### <Form of Tag Plate>

### 1. First Section of Tag Plate

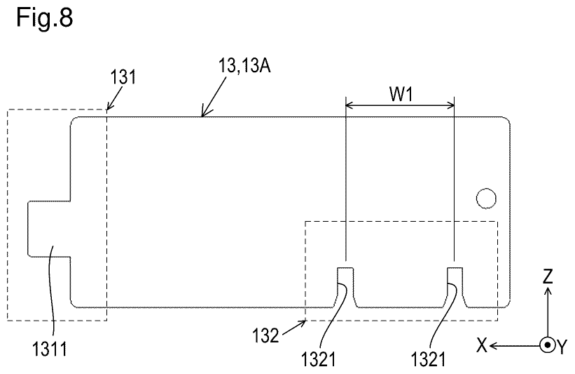

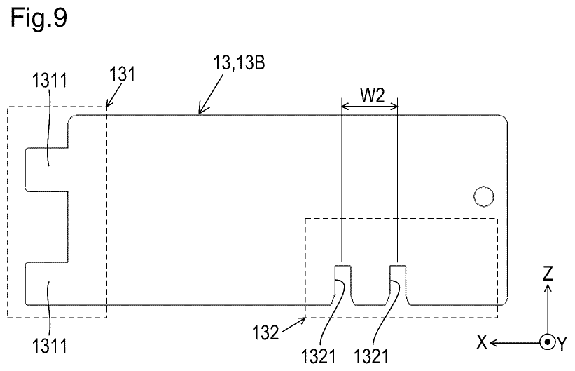

In the present embodiment, as shown in FIGS. 8 and 9, the tag plate 13 integrally includes a first section 131. In each of FIGS. 8 and 9, the first section 131 is enclosed by a broken line. The first section 131 is a part of the tag plate 13 that protrudes from the holder 22 toward the tray insertion direction in the state where the tag plate 13 has been entered into the holder 22.

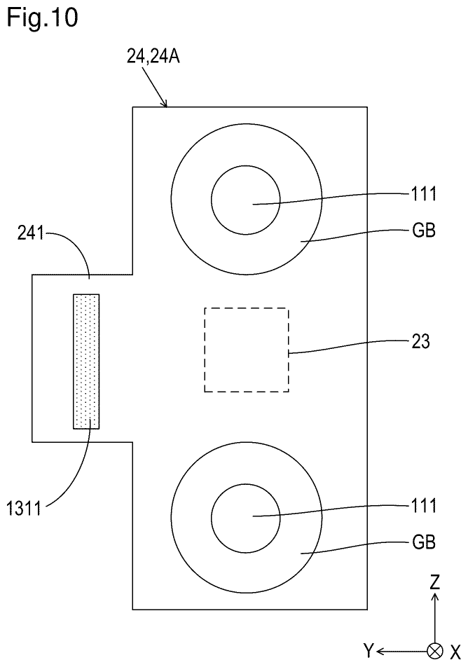

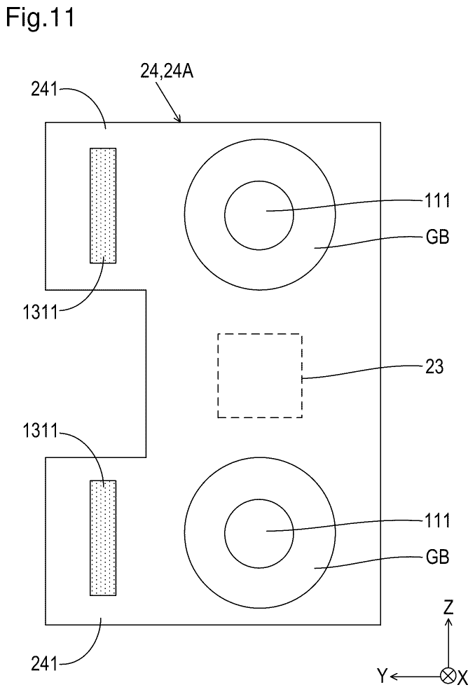

Further, as shown in FIGS. 10 and 11, the actuator 24 integrally includes a pressed piece 241. The pressed piece 241 is a part that protrudes leftward more than any other part of the actuator 24 as seen from the front-rear direction.

Here, the actuator 24 is formed to have one of a plurality of different shapes determined in advance. In the actuator 24, the shape of the pressed piece 241 varies depending on a destination of the inkjet recording apparatus 100.

For example, at least one of the number of pressed pieces 241 and the position of each pressed piece 241 varies depending on the destination of the inkjet recording apparatus 100. Here, for convenience of description, it is assumed that there are two destinations for the inkjet recording apparatus 100. In this case, two different shapes are determined in advance as options for a shape of the actuator 24.

In the case where the inkjet recording apparatus 100 has two destinations, the actuator 24 of the inkjet recording apparatus 100 for one destination has a single pressed piece 241 as shown in FIG. 10. Further, the single pressed piece 241 is disposed at a central part of the actuator 24 in the up-down direction.

Further, the inkjet recording apparatus 100 for the other destination has two pressed pieces 241 as shown in FIG. 11. Further, neither of the two pressed pieces 241 is disposed at the central part of the actuator 24 in the up-down direction, but they are respectively disposed above and below the central part in the up-down direction.

In the following description, the actuators 24 shown in FIGS. 10 and 11 may be distinguished by appending the letter “A” to the end of the sign of the actuator 24 shown in FIG. 10 and the letter “B” to the end of the sign of the actuator 24 shown in FIG. 11.

The first section 131 of the tag plate 13 is formed in a shape that corresponds to one of the plurality of different shapes determined in advance as the options for the shape of the actuator 24. That is, the shape of the first section 131 is changed depending on the determination of the inkjet recording apparatus 100.

Specifically, the first section 131 has at least one protruding portion 1311 that protrudes toward the tray insertion direction more than any other part of the first section 131 in the state where the tag plate 13 has been entered into the holder 22. Here, at least one of the number of protruding portions 1311 and the position of each protruding portion 1311 is changed corresponding to the shape of the actuator 24. In other words, the shape of the first section 131 is changed corresponding to the shape of the actuator 24. In still other words, the shape of the first section 131 is changed depending on the destination.

Hereinafter, a description will be given of correspondence between shapes of the tag plate 13 and the actuator 24, with a focus on actuators 24A and 24B.

The first section 131 of the tag plate 13 corresponding to the shape of the actuator 24A (see FIG. 10) has a shape as shown in FIG. 8. The first section 131 of the tag plate 13 corresponding to the shape of the actuator 24B (see FIG. 11) has a shape as shown in FIG. 9. In the following description, the tag plates 13 respectively corresponding to the actuators 24A and 14B may be distinguished by appending the letter “A” to the end of the sign of the tag plate 13 corresponding to the actuator 24A and the letter “B” to the end of the sign of the tag plate 13 corresponding to the actuator 24B.

As shown in FIG. 8, the tag plate 13A has a protruding portion 1311 at a substantially central part of the first section 131 in the up-down direction. In a state where the tag plate 13A has been entered into the holder 22 of the mounting portion 2 including the actuator 24A, as shown in FIG. 10, the protruding portion 1311 of the tag plate 13A is disposed frontward of the pressed piece 241 of the actuator 24A, facing the pressed piece 241 of the actuator 24A in the front-rear direction. Note that, in FIG. 10, for the sake of convenience, only the protruding portion 1311 is illustrated regarding the tag plate 13A.

As shown in FIG. 9, the tag plate 13B has the two protruding portions 1311 disposed one at each of two positions above and below the substantially central part of the first section 131 in the up-down direction. In a state where the tag plate 13B has been entered into the holder 22 of the mounting portion 2 including the actuator 24B, as shown in FIG. 11, the two protruding portions 1311 of the tag plate 13B are respectively disposed frontward of the two pressed pieces 241 of the actuator 24B, respectively facing the two pressed pieces 241 of the actuator 24B in the front-rear direction. Note that, in FIG. 11, for the sake of convenience, only the two protruding portions 1311 are illustrated regarding the tag plate 13B.

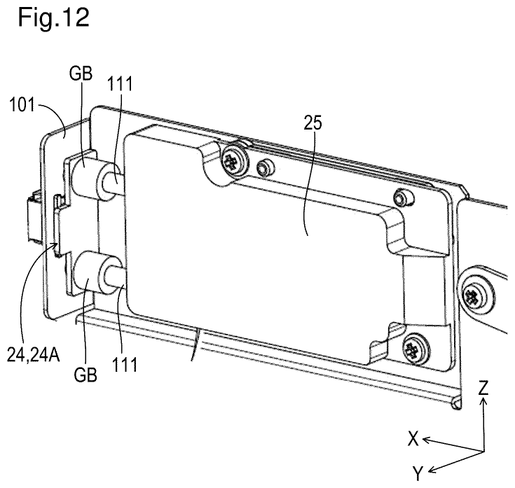

Thus, in a case where the tray 21 is inserted into the main body 10 in the state where the tag plate 13A has been entered into the holder 22 of the mounting portion 2 including the actuator 24A, the protruding portion 1311 of the tag plate 13A presses the pressed piece 241 of the actuator 24A in the tray insertion direction. Then, the actuator 24A moves in the tray insertion direction to press the switch 23 in the tray insertion direction (see FIG. 12). As a result, the switch 23 turns on.

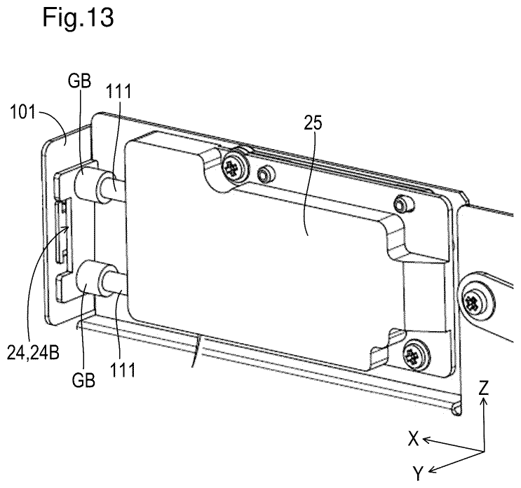

In a case where the tray 21 is inserted into the main body 10 in the state where the tag plate 13B has been entered into the holder 22 of the mounting portion 2 including the actuator 24B, the protruding portions 1311 of the tag plate 13B press the pressed pieces 241 of the actuator 24B in the tray insertion direction. Then, the actuator 24B moves in the tray insertion direction to press the switch 23 in the tray insertion direction (see FIG. 13). As a result, the switch 23 turns on.

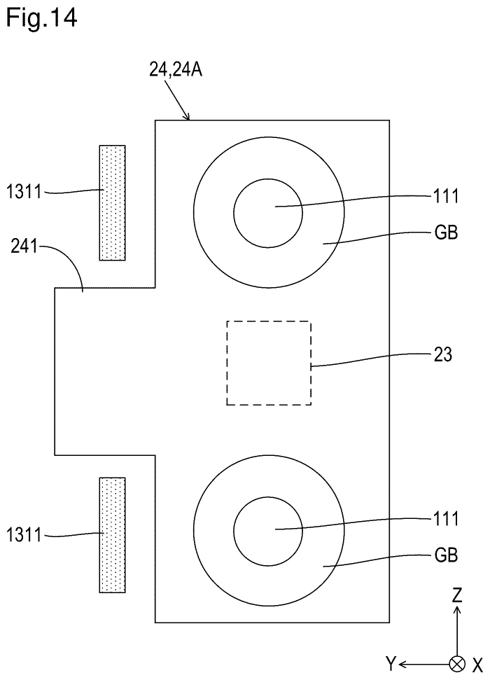

For example, as shown in FIG. 14, even if the tray 21 is inserted into the main body 10 in a state where the tag plate 13B has been entered into the holder 22 of the mounting portion 2 including the actuator 24A, the protruding portions 1311 of the tag plate 13B do not make contact with the pressed piece 241 of the actuator 24A. Further, although unillustrated, even if the tray 21 is inserted into the main body 10 in the state where the tag plate 13A has been entered into the holder 22 of the mounting portion 2 including the actuator 24B, the protruding portion 1311 of the tag plate 13A does not make contact with the pressed pieces 241 of the actuator 24B. In each of these cases, the actuator 24 does not move in the tray insertion direction. As a result, the switch 23 is not pressed and thus does not turn on.

In short, in the present embodiment, when the tray 21 is inserted into the main body 10, if the first section 131 of the tag plate 13 having been entered into the holder 22 has a shape corresponding to the shape of the actuator 24, the actuator 24 is pressed by the first section 131 in the tray insertion direction. When the actuator 24 is pressed and moves in the tray insertion direction, the switch 23 is pressed by the actuator 24 and thus the switch 23 turns on.

On the other hand, when the tray 21 is inserted into the main body 10, if the first section 131 of the tag plate 13 having been entered into the holder 22 does not have a shape corresponding to the shape of the actuator 24, the actuator 24 is not pressed by the first section 131 in the tray insertion direction, and thus the actuator 24 does not move in the tray insertion direction. As a result, the switch 23 is not pressed and thus does not turn on.

With this configuration, even if the ink pack 1 for one destination is set on the tray 21 for another destination and the tray 21 is inserted into the main body 10, the switch 23 does not turn on. If the switch does not turn on, the reading of the IC tag 130 by the tag reader 25 is not executed, and thus it is impossible to obtain the ink information necessary for printing execution. Thus, in a case where the destination of an ink pack 1 set in an inkjet recording apparatus 100 is different from the destination of the inkjet recording apparatus 100, it is possible to suppress execution of printing in that state. If printing is executed in the state where the destination of an ink pack 1 set in an inkjet recording apparatus 100 is different from the destination of the inkjet recording apparatus 100, it may result in degraded image quality. It may also cause malfunction of the inkjet recording apparatus 100.

In the present embodiment, it is possible to enable and disable the turning on and off of the switch 23 merely by changing the shape of the first section 131 of the tag plate 13, specifically, by changing at least one of the number of the protruding portions 1311 and the position of each protruding portion 1311.

This eliminates the need to adopt a configuration in which, for example, a non-compatible portion is integrally formed with the spout 12 to disable the mounting of the ink pack 1 on a non-compatible apparatus. If such a configuration is adopted, the spout 12 needs to be shaped differently for each destination, which will lead to an increase in cost.

In contrast, in the present embodiment, it is sufficient to simply change the shape of the first section 131 of the tag plate 13 and simply hang it on the spout 12. This makes it possible to suppress the mounting of the ink pack 1 in a non-compatible inkjet recording apparatus 100 while suppressing an increase in cost. As a result, it is possible to suppress printing execution with the inkjet recording apparatus 100 having a non-compatible ink pack 1 mounted therein.

### 2. Second Section of Tag Plate

In the present embodiment, as shown in FIGS. 8 and 9, the tag plate 13 integrally includes a second section 132. In each of FIGS. 8 and 9, the second section 132 is enclosed by a broken line. The second section 132 is a section that is entered into the holder 22.

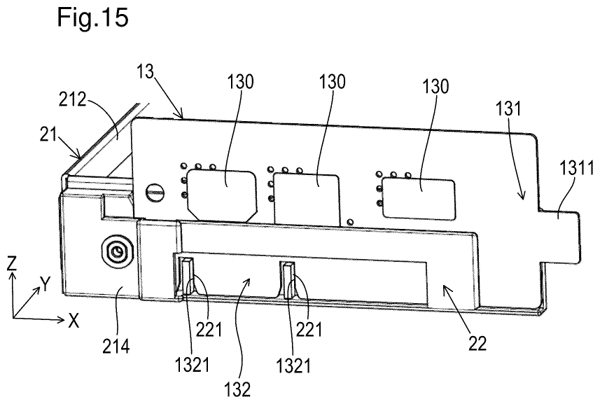

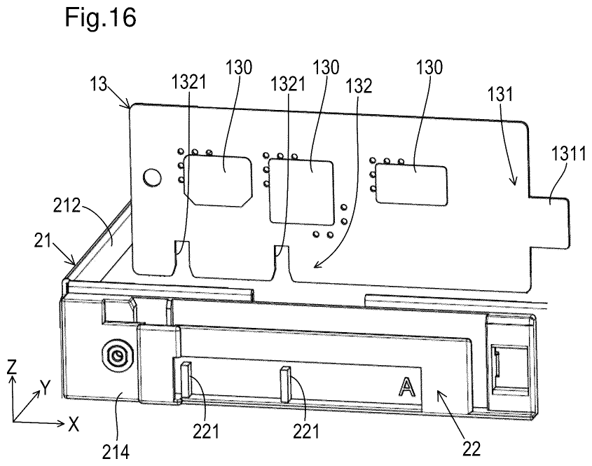

Further, as shown in FIGS. 15 and 16, the holder 22 integrally includes a rib 221. The rib 221 protrudes in the thickness direction of the tag plate 13 in the state where the tag plate 13 has been entered into the holder 22 (that is, the left-right direction) and also extends linearly in the tag entry direction. The rib 221 is disposed in the entry region of the holder 22 into which the tag plate 13 is entered. FIG. 15 shows a state where the tag plate 13 has been entered into the holder 22, and FIG. 16 shows a state where the tag plate 13 is about to be entered into the holder 22.

Here, the holder 22 (the entry region thereof) is formed to have one of a plurality of different shapes determined in advance. The shape of the holder 22 corresponds to one of a plurality of types of ink and varies depending on the type (e.g., color) of the corresponding ink. In other words, the shape of the holder 22 varies depending on the type of ink contained in the ink pack 1 to be mounted in the corresponding mounting portion 2. The holder 22 of the mounting portion 2 in which an ink pack 1 containing ink of a type is formed in the shape corresponding to the type of the ink contained in the ink pack 1.

For example, at least one of the number of the ribs 221 and the position of each rib 221 varies depending on the type of the corresponding ink. Here, for the sake of convenience, it is assumed that the position of each rib 221 varies depending on the color of the corresponding ink.

The holder 22 is provided with two ribs 221. However, this is not meant as a limitation. The holder 22 may be provided with three of more ribs 221, or may be provided with a single rib 221.

Note that used in the inkjet recording apparatus 100 are inks in four colors: cyan, magenta, yellow, and black. Thus, as options for the shape of the holder 22, there are four different shapes respectively corresponding to these four colors. That is, there are a holder 22 for cyan, a holder 22 for magenta, a holder 22 for yellow, and a holder 22 for black.

The holder 22 corresponding to one of cyan, magenta, yellow, and black has a shape as shown in FIGS. 15 and 16. Although unillustrated, the other three holders 22, respectively corresponding to the remaining three colors among cyan, magenta, yellow, and black have mutually different shapes, of which all differ from the shape shown in FIGS. 15 and 16.

The second section 132 of the tag plate 13 is formed in a shape that corresponds to one of the plurality of different shapes determined in advance as the options for the shape of the holder 22. The second section 132 of the tag plate 13 attached to the ink pack 1 containing the cyan ink has a shape corresponding to the shape of the holder 22 for cyan. The second section 132 of the tag plate 13 attached to the ink pack 1 containing the magenta ink has a shape corresponding to the shape of the holder 22 for magenta. The second section 132 of the tag plate 13 attached to the ink pack 1 containing the yellow ink has a shape corresponding to the shape of the holder 22 for yellow. The second section 132 of the tag plate 13 attached to the ink pack 1 containing the black ink has a shape corresponding to the shape of the holder 22 for black.

Specifically, the second section 132 includes at least one slit 1321 that penetrates the tag plate 13 in its thickness direction and is also cut in the second section 132 from a downstream edge thereof in the tag entry direction into the holder 22 (that is, on a lower edge in the up-down direction) toward an upstream side in the tag entry direction (that is, an upper side in the up-down direction). The slit 1321 is a portion in the second section 132 that is linearly cut upward from the lower edge thereof. Here, at least one of the number of slits 1321 and the position of each slit 1321 is changed corresponding to the shape of the holder 22. In other words, the shape of the second section 132 is changed corresponding to the shape of the holder 22. In still other words, the shape of the second section 132 is changed depending on the type of ink. Note that a width of the opening of the slit 1321 in the front-rear direction is wider than a width of the rib 221 in the front-rear direction.

Hereinafter, a description will be given of correspondence between shapes of the tag plate 13 and the holder 22, with a focus on tag plates 13A and 13B. Here, it is assumed that the tag plates 13A and 13B correspond to inks of different types (colors).

As shown in FIG. 8, the tag plate 13A includes two slits 1321 in the second section 132. As shown in FIG. 9, the tag plate 13B includes two slits 1321 in the second section 132. An inter-center distance W1 between centers of the two slits 1321 of the tag plate 13A in the front-rear direction (that is, the tray insertion direction) is greater than an inter-center distance W2 between the two slits 1321 of the tag plate 13B in the front-rear direction.

An inter-center distance between the two ribs 221 of the holder 22 corresponding to the tag plate 13A in the front-rear direction (that is, the tray insertion direction) is equal to the inter-center distance W1 between the two slits 1321 of the tag plate 13A. That is, when entering the tag plate 13A into the holder 22, positions of the two ribs 221 of the holder 22 and positions of the two slits 1321 of the tag plate 13A coincide with each other.

An inter-center distance between the two ribs 221 of the holder 22 corresponding to the tag plate 13B in the front-rear direction (that is, the tray insertion direction) is equal to the inter-center distance W2 between the two slits 1321 of the tag plate 13B. That is, when entering the tag plate 13B into the holder 22, positions of the two ribs 221 of the holder 22 and positions of the two slits 1321 of the tag plate 13B coincide with each other.

With this arrangement, the tag plate 13A is allowed to be entered into the holder 22 corresponding to the tag plate 13A. The tag plate 13B is allowed to be entered into the holder 22 corresponding to the tag plate 13B. On the other hand, the tag plate 13B is not allowed to be entered into the holder 22 corresponding to the tag plate 13A. Further, the tag plate 13A is not allowed to be entered into the holder 22 corresponding to the tag plate 13B.

That is, in the present embodiment, when the tag plate 13 has the second section 132 that has a shape corresponding to the shape of the holder 22, the tag plate 13 is allowed to be inserted into the holder 22. Specifically, by inserting the two ribs 221 of the holder 22 respectively into the two slits 1321 of the second section 132, the tag plate 13 is allowed to be entered into the holder 22. On the other hand, if the shape of the second section 132 of the tag plate 13 does not correspond to the shape of the holder 22, the positions of the ribs 221 and the slits 1321 in the front-rear direction do not coincide with each other, and thus the tag plate 13 is not allowed to be entered into the holder 22.

With this configuration, even if the ink pack 1 for one ink is set on the tray 21 for another ink, the tag plate 13 is not allowed to be entered into the holder 22. If the tag plate 13 has not been entered into the holder 22, even if the tray 21 is inserted into the main body 10, the switch 23 does not turn on. Thus, it is possible to suppress execution of printing in a state where the ink pack 1 for one ink is mounted in the mounting portion 2 for another ink.

The embodiment disclosed in this specification is merely an example in every aspect and should not be interpreted as a limitation. The scope of the present disclosure is defined not by the above description of the embodiment but by the claims, and should be understood to include all modifications within meaning and scope equivalent to the claims.

What is claimed is:

1. An image forming apparatus, comprising:
a container that contains a color material;
a mounting portion in which the container is mounted in an attachable and detachable manner; and
an image forming portion that forms an image on a sheet by using the color material, wherein
the container includes a tag plate including an IC tag in which color material information related to the color material is stored in advance,
the mounting portion includes
a tray that is insertable into and removable from a main body of the image forming apparatus and on which the container is set,
a holder that is disposed on the tray and that holds the tag plate of the container set on the tray by having the tag plate entered thereinto,
a switch that is disposed on the main body and that turns on and off by being pressed in an insertion direction, in which the tray is inserted into the main body, and
an actuator that is supported so as to be movable in the insertion direction and that moves in the insertion direction by being pressed in the insertion direction, thereby pressing the switch in the insertion direction,
the tag plate includes a first section that protrudes from the holder toward the insertion direction in a state where the tag plate has been entered into the holder,
the first section is formed in a shape that corresponds to one of a plurality of different shapes determined in advance as options for a shape of the actuator, and
when the tray is inserted into the main body, if a shape of the first section of the tag plate having been entered into the holder corresponds to the shape of the actuator, the actuator is pressed by the first section in the insertion direction.

2. The image forming apparatus according to claim 1,
wherein
the first section has at least one protruding portion that protrudes toward the insertion direction more than any other part of the first section in a state where the tag plate has been entered into the holder, and
when the shape of the first section of the tag plate having been entered into the holder corresponds to the shape of the actuator, the protruding portion faces the actuator in the insertion direction, such that the protruding portion is allowed to press the actuator.

3. The image forming apparatus according to claim 1,
wherein
the tag plate has a second section that is entered into the holder,
the second section is formed in a shape that corresponds to one of a plurality of different shapes determined in advance as options for a shape of the holder, and
when a shape of the second section of the tag plate corresponds to the shape of the holder, the tag plate is allowed to be entered into the holder.

4. The image forming apparatus according to claim 3,
wherein
the second section includes a slit that penetrates the second section in a thickness direction of the tag plate and that is cut in the second section from a downstream edge thereof in an entry direction, in which the tag plate is entered into the holder, toward an upstream edge thereof in the entry direction,
the holder has a rib that protrudes in the thickness direction in a state where the tag plate has been entered into the holder, and that extends in the entry direction, and
when the shape of the second section of the tag plate corresponds to the shape of the holder, a position of the slit of the second section entered into the holder coincides with a position of the rib, such that the tag plate is allowed to be entered into the holder.

5. The image forming apparatus according to claim 3,
wherein
the shape of the actuator varies depending on a destination of the mage forming apparatus, and
the shape of the holder varies depending on a type of the color material.

6. The image forming apparatus according to claim 1,
wherein
the container contains ink as the color material, and
the image forming portion ejects the ink toward the sheet, thereby forming an image on the sheet.
